(19) United States
(12) Patent Application Publication
(10) Pub. No.: US 2025/0026674 A1
(43) Pub. Date: Jan. 23, 2025

(54) Method and System for Optimizing Lightweight Biodigester

(71) Applicant: Yariv Glazer, Las Vegas, NV (US)

(72) Inventor: Yariv Glazer, Las Vegas, NV (US)

(21) Appl. No.: 18/777,538

(22) Filed: Jul. 18, 2024

Related U.S. Application Data
(60) Provisional application No. 63/514,536, filed on Jul. 19, 2023.

(51) Int. Cl. C02F 3/28; C02F 1/02; C02F 1/20; C02F 3/00

(52) U.S. Cl. CPC C02F 3/286; C02F 1/02; C02F 1/20; C02F 3/006; C02F 2209/06; C02F 2301/08; C02F 2301/10

(57) ABSTRACT

The present invention is a compact and portable system designed to optimize lightweight biodigesters. The system includes a small sewage receiving tank, at least one small anaerobic digesting tank, and at least one gray water receiving tank, all interconnected for efficient operation. Sewage introduced into the small sewage receiving tank undergoes hydrolysis digestion, where solids settle at the bottom and excess liquids with suspended solids overflow into the small anaerobic digesting tank. This second tank further processes the liquids through acidogenesis, acetogenesis, and methanogenesis digestion stages. The final overflow liquids are directed to the gray water receiving tank for safe disposal. The system also incorporates heating elements, pH controlling apparatus, water filters, and gas release mechanisms, ensuring effective and controlled digestion processes.

### RELATED APPLICATION

This application is a continuation application of U.S. Provisional Application No. 63/514,536, filed Jul. 19, 2023, and incorporates by reference the disclosure therein.

### FIELD OF INVENTION

The present invention relates to a method and system for optimizing lightweight biodigester.

### BACKGROUND OF INVENTION

The invention described below is particularly beneficial for managing the sewage disposal of mobile residences, such as recreational vehicles, tiny houses, boats, and similar structures. While the following description focuses on these specific applications, it should be noted that the invention can be applied to various other sewage management scenarios.

Numerous techniques exist for handling sewage disposal in mobile homes, including recreational vehicles, tiny houses, boats, and similar dwellings. Typically, these techniques involve emptying the sewage tank, commonly referred to as the black tank, into a designated sewage outlet at a dump station. Dump stations can usually be found in parks, gas stations, RV service stations, and marine docks.

One drawback of the known techniques arises when the mobile home is situated in a remote location without convenient access to a dump station. In such situations, the black tank must be emptied into a portable container, often called a mobile tote, which is then transported to the nearest dump station for cleaning. This process is unpleasant and prone to sanitary mishaps, such as accidental spillage of toxic sewage in inappropriate areas.

Another drawback of the prior art relates to situations where a boat remains away from the dock for an extended period, such as during long sailing trips. In such cases, a mobile tote is not a viable solution, and the boat must make intermittent stops to empty its sewage tank.

Further drawbacks of the existing techniques arise from the use of tiny houses that remain stationary in one location for several months. Moving the tiny house every few days is not a practical option, making an active sewage disposal procedure necessary.

### SUMMARY OF THE INVENTION

This summary is intended to disclose the present invention, method, and system for optimizing lightweight biodigester. The embodiments and descriptions are used to illustrate the invention and its utility and are not intended to limit the invention or its use. An object of the present invention is to provide a method and a system for optimizing lightweight biodigester in a manner having advantages in one or more of the above respects.

A system of optimizing lightweight biodigester comprises a small sewage receiving tank; at least one small anaerobic digesting tank; at least one gray water receiving tank; wherein the small sewage receiving tank is connected in a way that excess liquids overflow into the at least one small anaerobic digesting tank; the at least one small anaerobic digesting tank is connected in a way that excess liquids overflow into the at least one gray water receiving tank; wherein excess liquids from the sewage receiving tank, accompanied by suspended solids, overflow into the at least one small anaerobic digesting tank; and wherein the excess liquids from the at least one anaerobic digesting tank, overflow to the at least one gray water receiving tank for gray water disposal.

In some describe embodiments of the present invention, within the small sewage receiving tank, solids and liquids separate, with solids settling by force of gravity at the bottom to undergo hydrolysis digestion; wherein excess liquids, accompanied by suspended solids and byproducts resulting from the hydrolysis process, overflow into at least one small anaerobic digesting tank to undergo acidogenesis, acetogenic, and methanogenesis digestion; and wherein the excess liquids from the at least one anaerobic digesting tank, overflow to the at least one gray water receiving tank for gray water disposal.

Some described embodiments include a solid hygiene product trap for preventing hygiene product from harming said biodigestion process. Solid hygiene products include, but are not limited to, wipes, feminine napkins, and tampons. Other described embodiments include water filters connected for filtering liquids from said at least one small anaerobic digesting tank to said at least one gray water receiving tank. In other described embodiments the small anaerobic digesting tanks are connected to each other in series wherein the small sewage receiving tank is connected to a first small anaerobic digesting in said series, and overflow liquids flow from one small anaerobic digesting tank to the next in the series; and wherein the overflow liquids from the last small anaerobic digesting overflow into the at least one gray water receiving tank. Additional embodiments encompass apparatuses that facilitate the release of digesting gas products from the tanks, regulate the temperature within the tanks, and maintain optimal pH levels in the tanks. Examples of methods for controlling pH levels may include pH sensors positioned at various points within the digestion chamber to monitor the pH levels in real-time; alkalinity addition apparatus for adding alkaline substances to the digestion chamber; acid addition apparatus for adding acidic substances to the digestion chamber; and a central processor that receives data from the pH sensors and controls the addition of alkalic or acidic substances.

In one preferred embodiment of the present invention, a sailboat is equipped with a sewer system designed in accordance with this invention. During the voyage from California to Hawaii, the sewer system plays a crucial role in treating the sewage generated by the crew on board. When crew members flush the boat's toilet, the fresh biomaterial is directed into a sewage receiving tank, where a separation occurs between solid and liquid components. Solids settle at the bottom of the tank for hydrolysis digestion, while excess liquid, along with suspended solids and byproducts of hydrolysis, overflows into an anaerobic digestion tank. In this tank, a series of digestion processes, including acidogenesis, acetogenic, and methanogenesis, take place. Finally, the surplus liquid undergoes filtration and is directed towards the gray water receiving tank.

The invention offers significant advantages in prolonging the interval between sewage emptying in recreational environments. For instance, a camper equipped with a sewer system built according to this invention is parked at a location without sewer connections. With each flush of the toilet, a fresh batch of biomaterial is introduced into the small sewage receiving tank where the sewage undergoes hydrolysis digestion and solids separate from liquids, with solids settling at the bottom from the force of gravity. Excess liquids, along with suspended solids and byproducts generated during the hydrolysis process, overflow into a small anaerobic digesting tank for acidogenesis and acetogenic digestion. Subsequently, the surplus liquids, containing dissolved products from the acidogenesis and acetogenic digestion, overflow into a second small anaerobic digesting tank for methanogenesis digestion. Ultimately, the surplus liquids from the second anaerobic digesting tank pass through filters and reach the gray water receiving tank.

The present invention is particularly valuable for the maintenance of portable toilets at construction sites, where site managers strategically place portable toilets designed according to the present invention for the convenience of the site workers. After individuals have completed their use of the portable toilets, a trap specifically designed for hygiene waste collects the waste, enabling the fresh biomaterial to freely flow into a sewage receiving tank. Within this tank, solid and liquid components separate, with solids settling at the bottom from the force of gravity to undergo hydrolysis digestion. The remaining liquid, along with suspended solids and byproducts of hydrolysis, overflows into the first anaerobic digesting tank for acidogenesis digestion. Subsequently, the liquid flows into a second anaerobic digesting tank where acetogenic digestion occurs. Following this stage, the liquid containing dissolved products from acidogenesis and acetogenic digestion overflows into a third anaerobic digesting tank for methanogenesis digestion. Finally, the excess liquid from the methanogenesis digestion tank is filtered and directed to the gray water receiving tank.

The invention is particularly advantageous with respect to tiny houses that lack a sewer connection. In each of these houses, the sewage disposal system follows the specifications of this invention. When residents flush the toilet, a trap designed specifically for handling hygiene waste collects the waste, allowing the fresh biomaterial to flow freely into a sewage receiving tank where it undergoes hydrolysis digestion and where solids separate from liquid. The remaining liquid, along with suspended solids and byproducts of hydrolysis, overflows into the first tank dedicated to anaerobic digestion for acidogenesis. Subsequently, the liquid proceeds to a second anaerobic digesting tank, where acetogenic digestion takes place. Following this stage, the liquid, containing dissolved products resulting from both acidogenesis and acetogenic digestion, overflows into a third anaerobic digesting tank for methanogenesis digestion. Lastly, the surplus liquid from the methanogenesis digestion tank undergoes filtration and is directed to the gray water receiving tank.

Other preferred embodiments of the present invention describe a retired couple who sets off on a winter trip to southern Arizona. Throughout their journey, the couple stays in a motorhome equipped with a black tank that has been specially designed according to the present invention. Upon reaching their destination in the desert, located a few miles away from the nearest town, they choose to park without any external connections. When utilizing the toilet, a fresh batch of biomaterial is directed into the sewage receiving chamber within the black tank to undergo hydrolysis, initiating a separation process between solid and liquid components. Excess liquid, along with suspended solids and byproducts of hydrolysis, overflows into the first anaerobic chamber for acidogenesis digestion. Subsequently, the liquid overflows to the second anaerobic chamber for acetogenic digestion. After this stage, the liquid, which contains dissolved products resulting from both acidogenesis and acetogenic digestion, overflows into the third anaerobic chamber for methanogenesis digestion. Finally, the surplus liquid from the methanogenesis digestion tank undergoes filtration and is directed into the gray water tank.

Further preferred embodiments of the present invention depict a family that has purchased land with the intention of building their own house. While waiting for a sewer system to be constructed, the family sets up a camper on the land, equipped with a black tank designed in accordance with the present invention. Whenever the toilet is used, a specifically designed trap for hygiene waste collects the waste, allowing the fresh biomaterial to flow freely into a sewage receiving chamber for hydrolysis digestion. Inside this chamber, the flow comes to rest, allowing for the separation of solid and liquid components, with solids settling at the bottom under the force of gravity. The remaining liquid, along with suspended solids and byproducts of hydrolysis, overflows into the first anaerobic digesting chamber for acidogenesis digestion. Subsequently, the liquids overflow to a second anaerobic digesting chamber, where acetogenic digestion takes place. Following this stage, the liquid, containing dissolved products resulting from both acidogenesis and acetogenic digestion, overflows into a third anaerobic digesting chamber for methanogenesis digestion. Finally, the excess liquid from the methanogenesis chamber undergoes filtration and is directed to the gray water receiving tank.

Yet more preferred embodiments of the present invention describe train cars equipped with a sewer system designed in accordance with the current invention. When utilizing the toilets in these train cars, a specially designed trap for hygiene waste ensures that only biomaterial flows into a sewage receiving tank. Inside the tank, the biomaterial undergoes hydrolysis digestion while a circular flow is employed to facilitate a separation of solid and liquid components. As the solids settle at the bottom, they, while the remaining liquid, along with suspended solids and byproducts of hydrolysis, overflows into the first anaerobic digesting tank for acidogenesis digestion. Subsequently, the liquid progresses to a second anaerobic digesting tank where acetogenic digestion takes place. Following this stage, the liquid, which contains dissolved products resulting from both acidogenesis and acetogenic digestion, overflows into a third anaerobic digesting tank for methanogenesis digestion. Finally, the excess liquid from the methanogenesis tank is subjected to filtration and directed to the gray water receiving tank.

Still another preferred embodiment of the present invention pertains to off-grid cabins equipped with a sewer system designed in accordance with the current invention. The system ensures efficient waste management by incorporating a specially designed trap for hygiene waste, allowing only biomaterial to flow into a dedicated sewage receiving tank. Once inside the tank, the biomaterial undergoes hydrolysis digestion. To facilitate the separation of solid and liquid components, a circular flow is implemented. The solids settle at the bottom of the tank under the force of gravity, while the remaining liquid, along with suspended solids and byproducts of hydrolysis, overflows into the first anaerobic digesting tank for acidogenesis digestion. Subsequently, the liquid progresses to a second anaerobic digestion tank, where acetogenic digestion takes place. Following this stage, the liquid, which contains dissolved products resulting from both acidogenic and acetogenic digestion, overflows into a third anaerobic digesting tank for methanogenesis digestion. Finally, the excess liquid from the methanogenesis tank undergoes filtration and is directed to the gray water receiving tank.

Yet another preferred embodiment of the present invention describes remote research stations equipped with a sewer system designed in accordance with the current invention. When utilizing the facilities in these research stations, a trap for hygiene waste ensures that only biomaterial flows into a sewage receiving tank. Inside the tank, the biomaterial undergoes hydrolysis digestion, while a circular flow is employed to aid in the separation of solid and liquid components. As the solids settle at the bottom, they are retained, while the remaining liquid, along with suspended solids and byproducts of hydrolysis, overflows into the first anaerobic digesting tank for acidogenesis digestion. Subsequently, the liquid progresses to a second anaerobic digesting tank where acetogenic digestion takes place. Following this stage, the liquid, which contains dissolved products resulting from both acidogenesis and acetogenic digestion, overflows into a third anaerobic digesting tank for methanogenesis digestion. Finally, the excess liquid from the methanogenesis tank is subjected to filtration and directed to the gray water receiving tank, ensuring efficient waste management in remote research stations.

Further features and advantages of the invention will be apparent from the description below.

### BRIEF DESCRIPTION OF THE DRAWINGS

The present invention is illustrated with 8 drawings on 8 sheets.

FIG. 1 is a block diagram of a two-stage lightweight biodigester constructed in accordance with the invention.

FIG. 2 is a flow chart illustrating a method of implementing the system of FIG. 1.

FIG. 3 is a block diagram illustrating a three-stage lightweight biodigester constructed in accordance with the invention.

FIG. 4 is a flow chart illustrating a preferred method for implementing the system of FIG. 3.

The block diagram of FIG. 5 illustrates a portable toilet setup with hygiene trap installed in front of a three-stage lightweight biodigester constructed in accordance with the invention.

FIG. 6 is a flow chart illustrating a method of operation of the system shown in FIG. 5

FIG. 7 is a block diagram illustrating a black-tank sewage system using a four-stage lightweight biodigester constructed in accordance with the invention and

FIG. 8 is a flow chart illustrating a method of operation of the system shown in FIG. 7.

### DETAILED DESCRIPTION OF THE DRAWINGS

The following descriptions are not meant to limit the invention, but rather to add to the summary of invention, and illustrate the present invention, by offering and illustrating various embodiments of the present invention, a method and system for optimizing lightweight biodigester. While embodiments of the invention are illustrated and described, the embodiments herein do not represent all possible forms of the invention. Rather, the descriptions, illustrations, and embodiments are intended to teach and inform one skilled in the art without limiting the scope of the invention.

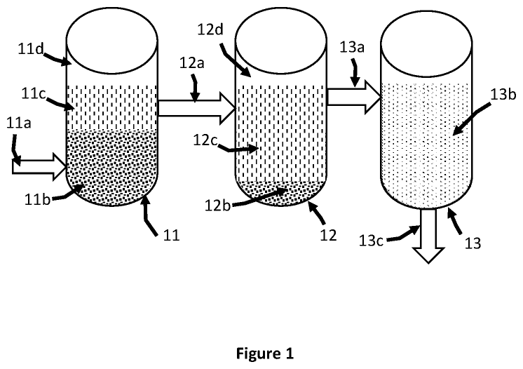

As shown in FIG. 1, the system consists of a sewage receiving tank (11) with a sewage inlet (11a) and a liquids overflow outlet (12a). Within the sewage receiving tank (11), solids (11b) separate from liquids (11c) and undergo hydrolysis digestion. Some of the hydrolysis byproducts are in a gas form (11d). The excess liquid (11c), along with suspended solids and hydrolysis byproducts, overflows (12a) into an anaerobic digestion tank (12), where the suspended solids (12b) separate from the liquids (12c). In the anaerobic digestion tank (12), a series of digestion processes occur, including acidogenesis, acetogenesis, and methanogenesis, resulting in liquid byproducts (12c) and gas byproducts (12d). The liquid byproducts (12c) mainly consist of water, while the gas byproducts (12d) include mainly methane and carbon dioxide. The excess liquid (12c) undergoes filtering (13a) before being transferred to a gray water tank. In the gray water receiving tank (13), the filtered water (13b) can be stored until it is used for irrigation through the outlet (13c).

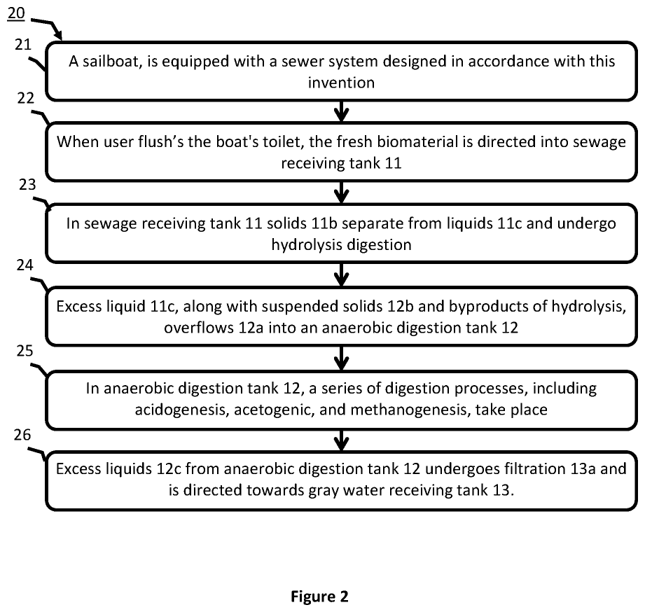

The flowchart depicted in FIG. 2 showcases one embodiment of the invention, identified as 20. In an application of this method, a sailboat equipped with a sewer system designed according to this invention embarks on a journey from California to Hawaii (21). As the crew members flush the boat's toilet (22), the fresh biomaterial is directed into the sewage receiving tank (11). Within the sewage receiving tank (11), solids (11b) separate from liquids (11c), and subsequently undergo hydrolysis digestion (23). The excess liquid (11c), along with suspended solids (12b) and hydrolysis byproducts (24), overflows (12a) into an anaerobic digestion tank (12). In the anaerobic digestion tank (12), various digestion processes, including acidogenesis, acetogenesis, and methanogenesis, occur (25). Finally (26), the excess liquids (12c) from the anaerobic digestion tank (12) undergo filtration (13a) and are directed towards the gray water receiving tank (13).

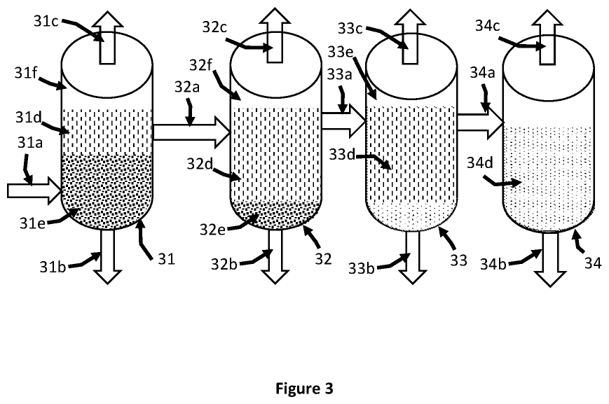

The system illustrated in FIG. 3, constructed based on the present invention, comprises a sewage receiving tank (31) equipped with a sewage inlet (31a) and a liquids overflow outlet (32a). Within the sewage receiving tank (31), there is a separation of solids (31e) from liquids (31d), which then undergoes an initial stage of digestion. To regulate the release of byproduct gases (31f) generated during digestion, a gas release valve (31c) is installed at the top of the sewage receiving tank (31). Additionally, located at the bottom of the sewage receiving tank (31), there is an outlet (31b) specifically designed for the removal of solids, facilitating the cleaning and winterization procedures.

The excess liquid (31d), along with suspended solids and digestion byproducts, overflows through the outlet (32a) into the first anaerobic digestion tank (32), where the suspended solids (32e) separate from the liquids (32d). Within the anaerobic digestion tank (32), both the solids (32e) and the liquids (32d) undergo acidogenesis and acetogenic digestion processes. To regulate the pressure resulting from the byproduct gases (32f), a gas release valve (32c) is installed at the upper part of the anaerobic digestion tank (32). Additionally, the first anaerobic digestion tank (32) is equipped with an outlet (32b) to facilitate cleaning and winterization procedures.

The excess liquid (32d), along with the digestion byproducts, then overflows (33a) into a secondary anaerobic digestion tank (33) for further digestion through methanogenesis. To regulate the pressure resulting from the byproduct gases (33f), a gas release valve (33c) is installed at the upper part of the anaerobic digestion tank (33). Additionally, the second anaerobic digestion tank (33) is equipped with an outlet (33b) to facilitate cleaning and winterization procedures. The excess liquid (33d) undergoes filtering (34a) before being transferred to a gray water tank (34), where the filtered water (34d) can be stored until it is used for irrigation through the outlet (34b).

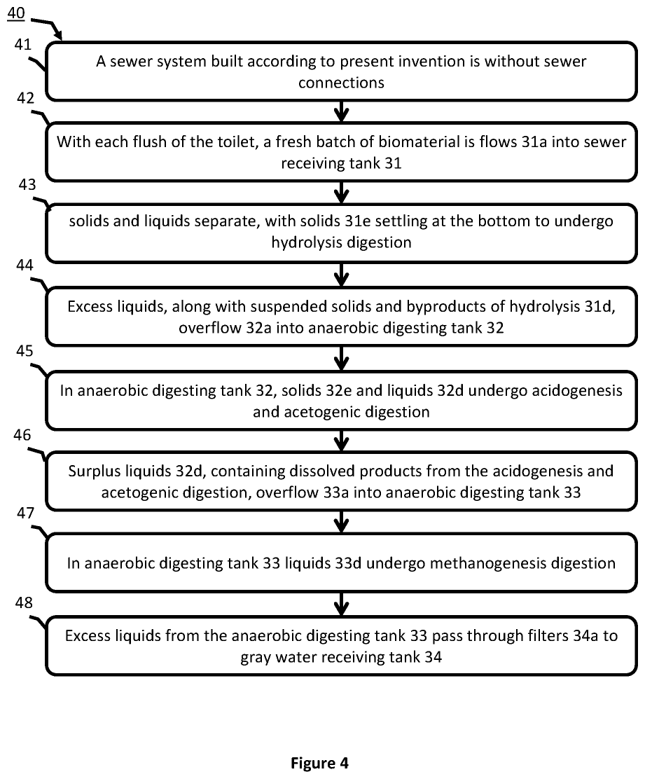

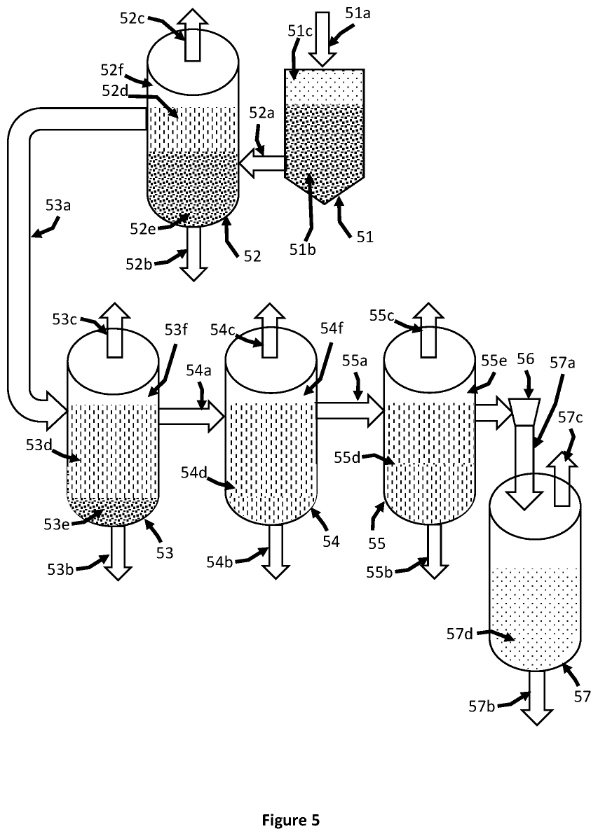

The flow chart in FIG. 4 illustrates an embodiment 40 of the invention shown in FIG. 3. A camper equipped with a sewer system built according to the present invention is parked at a location without sewer connections 41. With each flush of the toilet, a fresh batch of biomaterial flows 31a into sewage receiving tank 31, designated as 42. solids and liquids separate, with solids 31e settling at the bottom from the force of gravity to undergo hydrolysis digestion 43. Excess liquids, along with suspended solids and byproducts of hydrolysis 31d, overflow 32a into anaerobic digesting tank 32, designated as 44. In anaerobic digesting tank 32, solids 32e and liquids 32d undergo acidogenesis and acetogenic 45. Surplus liquids 32d, containing dissolved products from the acidogenesis and acetogenic digestion, overflow 33a into anaerobic digesting tank 33, designated as 46. In anaerobic digesting tank 33 liquids 33d undergo methanogenesis digestion, 47. Excess liquids from the anaerobic digesting tank 33 pass through filters 34a to gray water receiving tank 34, designated as 48.

The accompanying FIG. 5 presents an embodiment of the invention, providing a detailed description of the system's components and their functions. The system incorporates a hygiene products trap (51) designed to protect the digestion process. The hygiene products trap (51) features a sewage inlet (51a) and a sewage outlet (52a). Within the trap, solid hygiene products (51c) are effectively separated, allowing liquids with a high organic solids content (51b) to flow into the sewage receiving tank (52). The sewage receiving tank (52) comprises a sewage inlet (52a), a liquids overflow outlet (53a), and a gas release valve (52c). Within this tank, there is a distinct separation of solids (52e) from liquids (52d), with subsequent hydrolysis digestion occurring, potentially generating byproduct gases (52f). The tank is also equipped with an outlet (52b) positioned at the bottom to facilitate the removal of solids, simplifying the cleaning and winterization procedures.

Overflowing from the sewage receiving tank (52), excess liquid (52d), along with suspended solids and hydrolysis byproducts, flows through the outlet (53a) into a first anaerobic digestion tank (53). Within this tank, the suspended solids (53e) separate from the liquids (53d), both of which undergo acidogenesis digestion. To regulate the pressure resulting from the byproduct gases (53f), a gas release valve (53c) is positioned at the upper part of the anaerobic digestion tank (53). Furthermore, the first anaerobic digestion tank (53) is equipped with an outlet (53b) that facilitates cleaning and winterization procedures. Subsequently, the excess liquid (53d), along with acidogenesis byproducts, overflows through the outlet (54a) into a second anaerobic digestion tank (54) for acetogenic digestion. Similar to the previous tank, a gas release valve (54c) is placed at the upper part of the second anaerobic digestion tank (54) to regulate the resulting byproduct gases (54f). Additionally, an outlet (54b) is incorporated into the tank design to simplify cleaning and winterization procedures.

Following the same pattern, the excess liquid (54d), along with acetogenic digestion byproducts, overflows through the outlet (55a) into a third anaerobic digestion tank (55) designated for methanogenesis digestion. To regulate the pressure caused by the byproduct gases (55e), a gas release valve (55c) is positioned at the upper part of the anaerobic digestion tank (55). Similar to the previous tanks, an outlet (55b) is present to facilitate cleaning and winterization processes. Finally, the overflow liquid (55d) is subjected to filtration (56) before being directed to a gray water tank (57). The filtered water (57d) is stored in the gray water tank (57) until it is utilized for irrigation through the outlet (57b). This comprehensive system, as illustrated in the patent drawing, showcases the arrangement and functionality of its various components, ensuring efficient digestion and management of waste materials.

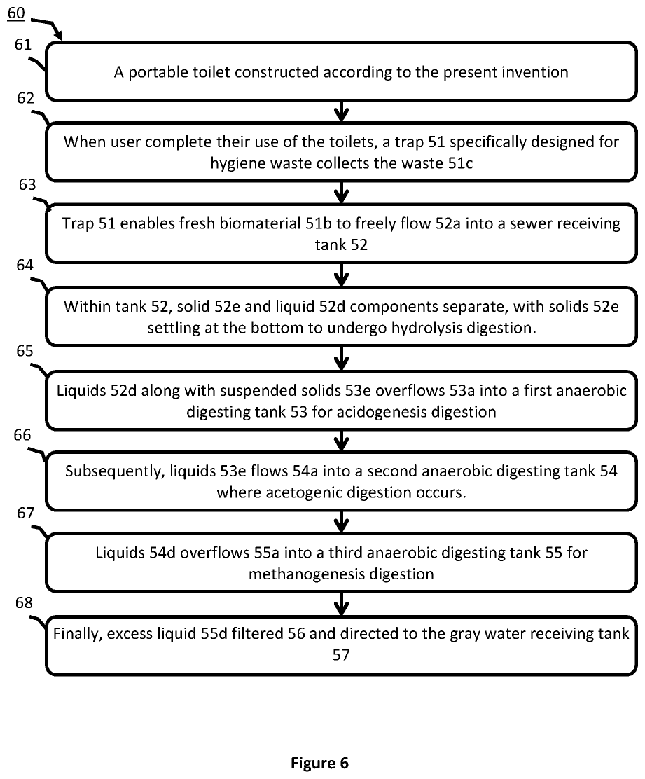

The flowchart of FIG. 6 illustrates an embodiment (60) of the invention as shown in FIG. 5. This embodiment generally describes a construction site where the placement of portable toilets by the construction site manager (61) ensures the convenience of site workers. Once the workers have used the toilets, a specialized hygiene waste trap (51) collects the waste materials (62). The trap (51) allows the free flow of fresh biomaterial (51b) through 52a into the sewage receiving tank (52) (63). Within the sewage receiving tank (52), the solid components (52e) and liquid components (52d) separate, with the solids settling at the bottom from the force of gravity for hydrolysis digestion (64). The liquids (52d), along with suspended solids (53e), overflow (53a) into the first anaerobic digesting tank (53) for acidogenesis digestion (65). Subsequently, the liquids (53e) flow (54a) into the second anaerobic digesting tank (54) for acetogenic digestion (66). The liquids (54d) then overflow (55a) into the third anaerobic digesting tank (55) for methanogenesis digestion (67). Finally, the excess liquid (55d) is filtered (56) and directed to the gray water receiving tank (57) (68). The flowchart in FIG. 6 outlines the sequential process and interconnection of the various components within the invention, highlighting the systematic treatment and management of waste materials specifically tailored for construction site environments.

This embodiment can also be applied for use in tiny houses and similar structures.

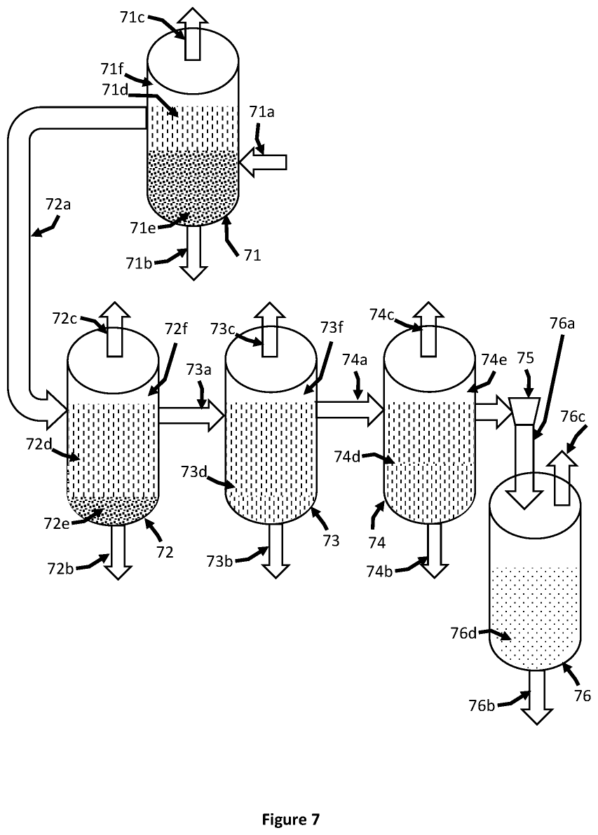

The system illustrated in FIG. 7 represents another embodiment of the invention, where a motorhome equipped with a black tank specially designed according to the present invention parks in the desert without any external connections. The first chamber of the black tank is a sewage receiving chamber (71) comprises a sewage inlet (71a), a liquids overflow outlet (72a), and a gas release valve (71c). Within the sewage chamber, solids (71e) separate from liquids (71d), and hydrolysis digestion, which may generate byproduct gases (71f) occurs. The sewage chamber (71) is further equipped with a bottom outlet (71b) for convenient removal of solids during cleaning and winterization procedures. Overflowing from the sewage receiving chamber (71), the excess liquid (71d) containing suspended solids and hydrolysis byproducts is directed through the outlet (72a) into the first anaerobic digestion chamber (72). Within this chamber, the suspended solids (72e) separate from the liquids (72d), both of which undergo acidogenesis digestion. To regulate the pressure resulting from the byproduct gases (72f), a gas release valve (72c) is positioned at the upper part of the anaerobic digestion chamber (72). Additionally, the first anaerobic digestion chamber (72) is equipped with an outlet (72b) to facilitate cleaning and winterization procedures.

Subsequently, the excess liquid (72d), along with acidogenesis byproducts, overflows through the outlet (73a) into the second anaerobic digestion tank (73) for acetogenic digestion. Similar to the previous chamber, a gas release valve (73c) is installed at the upper part of the second anaerobic digestion chamber (73) to regulate the resulting byproduct gases (73f). Furthermore, the second anaerobic digestion chamber (73) incorporates an outlet (73b) to facilitate cleaning and winterization procedures. Following the same operational pattern, the excess liquid (73d), along with acetogenic digestion byproducts, flows through the outlet (74a) into the third anaerobic digestion chamber (74) designated for methanogenesis digestion. To regulate the pressure resulting from the byproduct gases (74e), a gas release valve (74c) is positioned at the upper part of the anaerobic digestion chamber (74). Similarly, the third anaerobic digestion chamber (74) includes an outlet (74b) for cleaning and winterization purposes.

Finally, the overflow liquid (74d) undergoes filtration (75) before being directed to the gray water tank (76). The filtered water (76d) is stored in the gray water tank (76) until it is utilized for irrigation through the outlet (76b). The patent drawing showcases the arrangement and functionality of the various components, ensuring effective digestion and management of waste materials in a comprehensive manner.

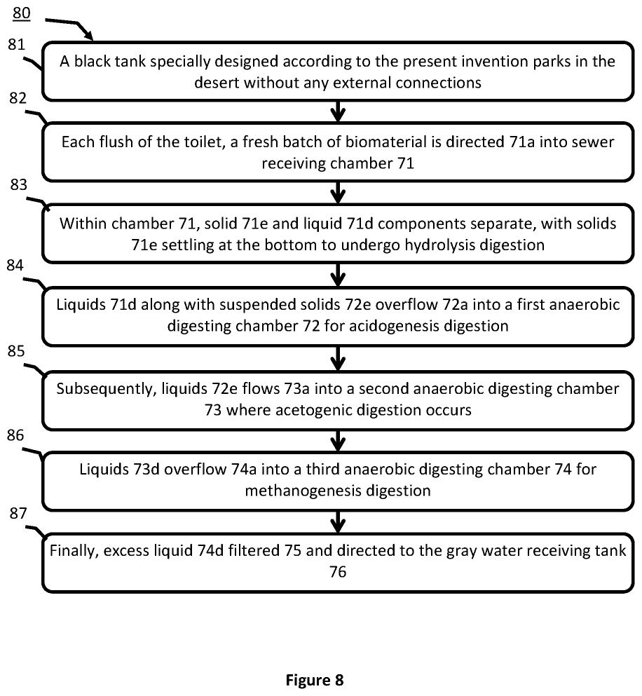

FIG. 8 presents more embodiments (80) of the invention shown in FIG. 7, specifically depicting a motorhome equipped with a specially designed black tank in accordance with the present invention. In this embodiment, the motorhome parks in the desert without any external connections (81). With each flush of the toilet, a fresh batch of biomaterial is directed (71a) into the sewage receiving chamber (71) (82). Within the sewage receiving chamber (71), the sewage undergoes hydrolysis digestion while solids (71e) and liquids (71d) separate with solids (71e) settling at the bottom (83) from the force of gravity. The liquids (71d), along with suspended solids (72e), overflow (72a) into the first anaerobic digesting chamber (72) for acidogenesis digestion (84). Subsequently, the liquids (72e) flow (73a) into the second anaerobic digesting chamber (73) where acetogenic digestion takes place (85). The liquids (73d) then overflow (74a) into the third anaerobic digesting chamber (74) designated for methanogenesis digestion (86). Finally, the excess liquid (74d) undergoes filtration (75) before being directed to the gray water receiving tank (76) (87).

This embodiment of the invention can be applied to any type of motorhome, whether mobile or stationary.

I claim:

1. A system of optimizing lightweight biodigester comprising:
a small sewage receiving tank;
at least one small anaerobic digesting tank;
at least one gray water receiving tank;
wherein the small sewage receiving tank is connected in a way that excess liquids overflow into the at least one small anaerobic digesting tank; and the at least one small anaerobic digesting tank is connected in a way that excess liquids overflow into the at least one gray water receiving tank;
wherein when sewage is dumped into the small sewage receiving tank, fresh biowaste is introduced into the small sewage receiving tank, causing excess liquid, accompanied by suspended solids, to overflow into the at least one small anaerobic digesting tank; and
wherein the excess liquids from the at least one anaerobic digesting tank, overflows into the at least one gray water receiving tank for gray water disposal.

2. The system of optimizing lightweight biodigester in claim 1, wherein within the small sewage receiving tank, the sewage undergoes hydrolysis digestion and solids separate from liquids, with solids settling at the bottom from the force of gravity;
wherein excess liquids, accompanied by suspended solids and byproducts resulting from the hydrolysis process, overflow into the at least one small anaerobic digesting tank to undergo at least one of acidogenesis, acetogenic, and methanogenesis digestion; and
wherein the excess liquids from the at least one anaerobic digesting tank, overflows to the at least one gray water receiving tank for gray water disposal.

3. The system of optimizing lightweight biodigester in claim 1, wherein the system is portable.

4. The system of optimizing lightweight biodigester in claim 1, wherein the system is installed on a mobile platform.

5. The system of optimizing lightweight biodigester in claim 1, further comprising a solids trap to prevent harm from to the digestion process wherein the solids trap is designed to trap at least one of wipes, tampons, and feminine napkins.

6. The system of optimizing lightweight biodigester in claim 1, further comprising a heating element for controlling the temperature of the small sewage receiving tank.

7. The system of optimizing lightweight biodigester in claim 1, further comprising a heating element for controlling the temperature of the at least one small anaerobic digesting tanks.

8. The system of optimizing lightweight biodigester in claim 1, further comprising:
at least one pH sensor;
at least one alkaline addition device;
at least one acid addition device;
at least one processor;
wherein the pH levels within the tanks are being continuously monitoring using pH sensors and the processor analyze the pH data to determine deviations from an optimal pH range;
wherein the processor activates the alkaline addition device to add an alkaline substance to the tank when the pH level is below the optimal range;
wherein the processor activates the acid addition device to add acidic substance to the tank when the pH level is above the optimal range.

9. The system of optimizing lightweight biodigester in claim 8, wherein the pH level is controlled in the at least one small sewage receiving tanks.

10. The system of optimizing lightweight biodigester in claim 8, wherein the pH level is controlled the at least one small anaerobic digesting tanks.

11. The system of optimizing lightweight biodigester in claim 1, further comprising at least one water filter connected for filtering liquids from the at least one small anaerobic digesting tank to the at least one gray water receiving tank.

12. The system of optimizing lightweight biodigester in claim 1,
wherein the small anaerobic digesting tanks are connected to each other in series;
wherein the small sewage receiving tank is connected to a first small anaerobic digesting tank in the series, and overflow liquids flow from one small anaerobic digesting tank to the next in the series; and
wherein the overflow liquids from the last small anaerobic digesting spill into the at least one gray water receiving tank.

13. The tanks in claim 1, further comprising a gas release apparatus for releasing digesting gas products from the tanks.

14. A method for optimizing lightweight biodigester comprising the following steps:
connecting a small sewage receiving tank to at least one small anaerobic digesting tank in a way that liquids overflow from the sewage receiving tank into the at least one small anaerobic digesting tank;
connecting the at least one small anaerobic digesting tank to at least one gray water receiving tank in a way that liquids overflow from the at least one small anaerobic digesting tank into the at least one gray water receiving tank;
dumping sewage into the small sewage receiving tank;
separating solids and liquids, with solids settling at the bottom from the force of gravity;
digesting the solids using hydrolysis;
draining the overflow of the small sewage receiving tank into the at least one small anaerobic digesting tank;
digesting the contents of the at least one small anaerobic digesting tank using at least one of acidogenesis, acetogenic, and methanogenesis digestion; and
draining the excess liquid from the at least one small anaerobic digestion tank to the at least one gray water receiving tank for gray water disposal;
wherein the overflow of the small sewage receiving tank is excess liquids, accompanying suspended solids, and other byproducts resulting from the hydrolysis process.

15. The method of optimizing lightweight biodigester of claim 14, comprising the further step, inserted prior to dumping sewage into the small sewage receiving tank, of passing the sewage through a solids trap designed to capture at least one of wipes, tampons, and feminine napkins.

16. The method of optimizing lightweight biodigester of claim 14, wherein water, from the at least one small anaerobic digesting tank, undergoes additional filtering before moving into the at least one gray water receiving tank.

17. The method of optimizing lightweight biodigester of claim 14, wherein the small anaerobic digesting tanks connect to each other in series for improving the efficacy of the anaerobic digesting process.

18. The method of optimizing lightweight biodigester of claim 14, wherein gas products, from the digesting process, released from the tanks.
